(19) United States
(12) Patent Application Publication
(10) Pub. No.: US 2013/0322485 A1
(43) Pub. Date: Dec. 5, 2013

(54) BURNER INSERT FOR AN ARC FURNACE

(71) Applicants: Markus Dorndorf, Baden-Baden (DE); Michael Henrich, Willstatt (DE)

(72) Inventors: Markus Dorndorf, Baden-Baden (DE); Michael Henrich, Willstatt (DE)

(21) Appl. No.: 14/001,285

(22) PCT Filed: Feb. 8, 2012
(86) PCT No.: PCT/EP2012/052116

§ 371 Date: Aug. 23, 2013

(30) Foreign Application Priority Data
Feb. 23, 2011 (DE) 10 2011 004 586.4

(51) Int. Cl. F27B 3/08; F27B 3/20

(52) U.S. Cl. CPC F27B 3/085; F27B 3/205
USPC 373/2

(57) ABSTRACT

A burner insert for an arc furnace has a support frame which can be inserted into a wall opening of a side wall of the arc furnace and a burner arranged in the support frame. The support frame is pivotably mounted around a pivot axis relative to the side wall between a park position and an operating position in the installed state of the burner insert. In the park position, the support frame and burner are located outside and, in the operating position, at least partially inside an inner chamber of the arc furnace.

### CROSS REFERENCE TO RELATED APPLICATIONS

This application is based on and hereby claims priority to International Application No. PCT/EP2012/052116 filed on Feb. 8, 2012 and German Application No. 10 2011 004 586.4 filed on Feb. 23, 2011, the contents of which are hereby incorporated by reference.

### BACKGROUND

The invention relates to a burner insert for an arc furnace.

In many steelworks, scrap metal is melted in an electric arc furnace and reprocessed into steel as part of a recycling process. In an arc furnace of said type, three electrodes which are supplied with three-phase current generate an arc of roughly 8000° C. of heat for melting the steel scrap. Additionally, burners such as natural gas/oxygen burners combined with oxygen ultrasound injectors are employed for inputting fossil energy into the arc furnace. The corresponding burners are used both for supporting the arc in terms of energy input and also for evening out the heat input. A corresponding electric arc furnace has a diameter of approx. 6-8 m. In this case the burners are distributed around the periphery of the typically approximately circular arc furnace.

An arc furnace of this type has a refractory molten metal vessel on its underside as a bottom vessel. Of course, the design of the arc furnace can vary widely. However, according to one potential embodiment, on the bottom vessel is placed a roughly annular top vessel formed of 8-10 panels arranged in annular fashion which, for example, have dimensions of roughly 1.8 m high and 1.20 m wide. These panels support copper pipes which have cooling water flowing through them. Let into the side walls, or into several or all of the wall panels, are wall openings measuring e.g. 80 cm×40 cm. In the case of known arc furnaces, nose panels protruding into the inner chamber of the furnace in nose-like fashion are placed in said wall openings. These in turn contain the aforesaid fossil fuel burners. In other words, the burners are held in projections protruding into the inner chamber in nose-like fashion so that the burners or their flame outlet apertures are offset radially inward from the inner wall of the top vessel. The reach of the burner flame toward the steel scrap that is to be melted is thus improved. On the other hand, the refractory material in the arc furnace, which lines the bottom vessel in particular, is thus protected from the burner flame or its thermal effect. The direct blasting of a flame onto the refractory material would destroy said material considerably more rapidly.

The aforesaid burner or nose panels are particularly at risk due to the input of steel scrap from scrap baskets. In this case the scrap is thrown into the inner chamber of the furnace from above. The fall height and the intrinsic weight of the steel scrap mean that at the time of the impact of scrap, high mechanical forces, inter alia, are exerted on the upper side of the burner panels, which panels are then often damaged beyond repair by impacting pieces of steel. Since, in addition, the burner panels are installed permanently in the wall panels, the orientation and angle and also the position of the burner flame are fixed with reference to the bottom vessel, i.e. invariable. This means that the angle and reach of the burner flame and the ultrasound oxygen beam are also invariable. Since the steel scrap and its distribution in the furnace vessel are variable from batch to batch, however, a high level of efficiency of the statically, i.e. invariably, installed burners is not always realized.

A burner insert of modular construction from the company Siemens for example is known, as the product Simetall^{CIS} RCB, as a solution to the damage problem. In this case the top and bottom covers of the burner insert protruding into the inner chamber of the furnace in nose-like fashion in particular can be replaced in modular fashion as solid copper plates if they are damaged. This reduces the downtime of a furnace during maintenance periods and the material costs since the entire burner panel does not need to be replaced.

### SUMMARY

One potential object is to disclose an improved burner insert for an arc furnace.

The inventors propose a burner insert having a support frame which can be inserted into a wall opening of a side wall of an arc furnace. A burner is arranged in the support frame. According to the proposals, the support frame is pivotably mounted around a pivot axis relative to the side wall between a park position and an operating position in the installed state of the burner insert, i.e. when said insert is inserted into the wall opening of the arc furnace. The park position is characterized in that support frame and burner are located outside an inner chamber of the arc furnace. In the operating position, on the other hand, support frame and burner are located at least partially inside the inner chamber.

In the park position, for example, the burner insert or its end surface facing the furnace closes off flush with the side wall. With the inventors' proposal, it is possible to swivel the burner insert into the park position and therefore remove said insert from the inner chamber of the arc furnace during the loading of the arc furnace with steel scrap—also referred to as charging. Thus, falling steel scrap cannot strike the burner insert from above and therefore also cannot damage it or only to a lesser degree—i.e. comparable with the damage to other wall panels or side walls of the top vessel.

Since in general the burner is permanently installed in the support frame, the swiveling of the support frame also means that the burner can be swiveled. At the start of the melting operation or in order to use the burner, the burner insert is consequently swiveled into the operating position—after the loading of the furnace—with the result that the burner is also moved into the inner chamber of the arc furnace. As a rule, the outlet aperture for the burner flame is therefore also swiveled toward the inner chamber so that the burner flame can act particularly effectively.

Since the burner can also be swiveled together with the support frame, its burner jet orientation in particular can be varied if intermediate settings of the pivot movement between the operating and park positions can also be assumed. Thus, the angle of the support frame or, as the case may be, the angle of the burner jet can be adjusted to the respective requirements during a melting operation by corresponding pivoting around the pivot axis. The usefulness of the burner can therefore be optimized.

In other words, the problems described above are solved or the burner insert optimized as a result of said insert being mounted pivotably. The displacement or swiveling is effected for example by a hydraulic cylinder or some other drive system, such as a chain or gear wheel drive.

If so desired, the support frame or the entire burner insert can be swung out of the furnace at least shortly prior to the charging so that falling scrap cannot impact—at least not from above—and damage the burner insert. Then, for example on the basis of an analysis by a measurement system, the burner panel is automatically swung around the pivot axis into the furnace by hydraulic cylinders. In this case a measurement system enables findings about the behavior and position of the scrap in the furnace, in order to improve the efficiency of the burners or burner flame by a tracking function.

The burner insert results in a mechanical protective arrangement for the burner panel during charging. This is realized in that when moved into the park position the burner insert is safe from damaging scrap. This means that the service life of the burner panel is extended and operational reliability is increased. The pivotable mounting and in particular the automatic tracking of the pivot angle of a burner panel mean that automatic tracking of the burner flame and therefore alignment with the progress of the process or the current state of the scrap in the furnace are also possible. This means that it is possible to increase the efficiency of the burner insert.

In a preferred embodiment, the support frame can additionally be pivoted around the pivot axis into a maintenance position. In the maintenance position, the burner and the support frame are located in an outer chamber of the arc furnace and in particular are accessible from said chamber. For example, the support frame is then pivoted from the operating position beyond the park position farther to the outside, e.g. fully out of the furnace or the side wall, until the support frame or part of it has left the wall opening. In particular, the burner is thus accessible for maintenance purposes for example.

The option is thus additionally created to swivel the burner panel into a position outside the furnace to be able to carry out maintenance and repair work easily and safely. Disassembly of the wall panel or the formerly permanently installed burner insert is obviated since, in contrast to this, the pivot movement can be executed easily. The complete swiveling out of the burner insert means that very good access for maintenance and repair work is realized, or access is improved and simplified.

In a preferred embodiment, the support frame penetrates the wall opening such that it almost completely fills said opening at least both in the operating and in the park positions. In other words, the burner insert fills the wall opening virtually over its complete area and without gaps. This means that no scrap or gas can escape from the furnace, in particular also during charging. Then, likewise in the operating position, no heat, gas or pieces of scrap, or liquid metal can escape. In particular, the support frame is configured such that it also likewise completely fills the wall opening without gaps in every intermediate position between operating and park positions.

In a preferred variant of this embodiment, the latter is achieved particularly easily in that the support frame has an external surface configured substantially as a segment of a circle with reference to the pivot axis. It has this external surface at least in the zone that is covered by the wall opening during a movement of the burner insert between the operating and park positions. In other words, the burner insert or the support frame then has, for example, an external shape corresponding to that of an angular segment of a level, straight regular cylinder, the pivot axis representing the central longitudinal axis of the regular cylinder. Expressed in layman's terms, the shape then resembles, for example, that of a traditional piece of pie.

In a preferred embodiment, the burner is arranged spaced apart from the pivot axis. It is achieved by this means that in particular the outlet aperture of the burner for the burner flame can be varied with reference to its spacing from the side wall and its angle of inclination with respect to the bottom vessel. The flame axis is therefore likewise pivotable around the pivot axis. A particularly flexible deployment capability of the burner flame is thus ensured.

In a further preferred embodiment, the pivot axis extends horizontally underneath the burner in the installed state of the burner insert in the arc furnace and at the same time forms the lower end of the support frame or burner insert.

The side of the burner insert pointing toward the inner chamber of the furnace in the park position then forms, for example, a section of the inner wall of the arc furnace ending flush with the remaining inner wall. This side is then, for example, implemented with particular robustness and mechanical stability. The said side has, for example, an outlet aperture for the burner flame. Pivoting into the inner chamber means that this side of the burner insert is then inclined toward the bottom vessel and there also forms good protection against molten steel splashing up.

The remaining sides of the burner insert can be implemented with significantly less robustness and stability since these, in particular when in the park position, are then located outside the arc furnace and not in the danger zone where there is risk of damage during the charging.

In a preferred embodiment, varying the pivot angle at least between the park and operating positions, that is to say traversing into intermediate positions, means that the burner insert can be adjusted to or tracked with the melting process or the scrap behavior. This can also be effected automatically in a controlled manner through measuring the volume of scrap, type of scrap, etc.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a detail of an arc furnace with burner insert in the park position,

FIG. 2 shows the burner insert from FIG. 1 in the operating position,

FIG. 3 shows the burner insert from FIG. 1 in the maintenance position.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

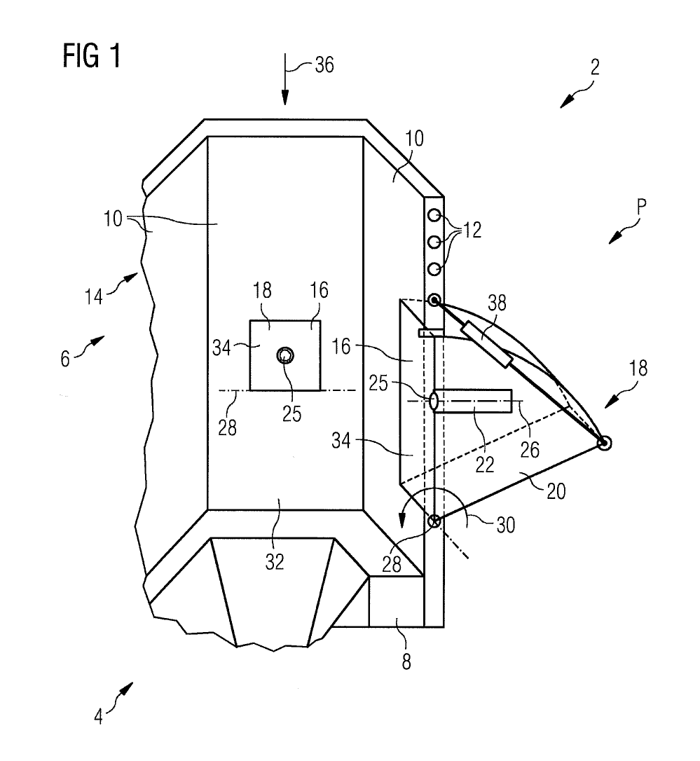

FIG. 1 shows an arc furnace 2 including a bottom vessel 4, which is only suggested in each case, and a top vessel 6. The bottom vessel 4 is formed of refractory material or is at least lined with said material on the inner side and forms a melting vat 8 for receiving steel scrap (not shown) which is to be melted into liquid steel there.

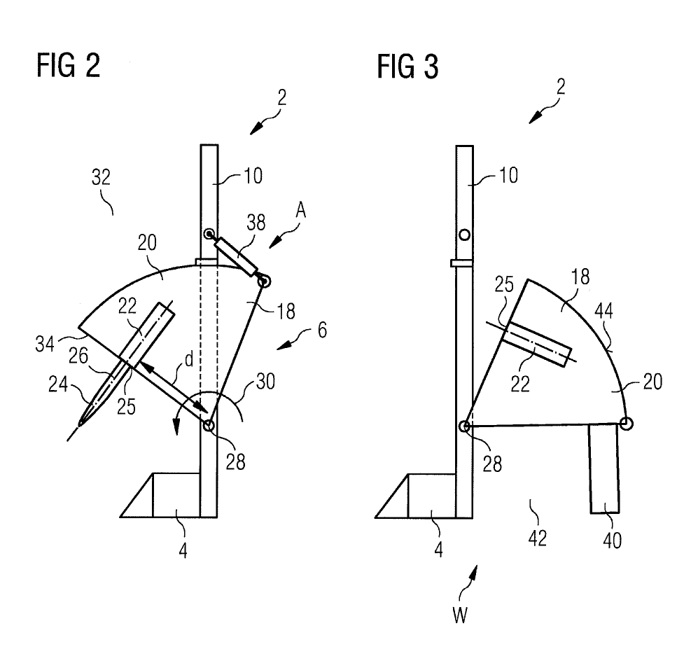

The top vessel has a series of wall panels 10 with cooling pipes 12 running in their interior. The wall panels 10 jointly form the top vessel 6 or a side wall 14 of the arc furnace 2. At least some of the wall panels 10 have wall openings 16 in which respective burner inserts 18 are inserted. The burner inserts 18 in each case include a support frame 20 and also a burner 22 which generates a burner flame 24 along a flame direction 26 during operation (see FIG. 2), indicated in FIG. 1 by a dashed line since the burner 22 is not active at that time.

According to the proposal, the burner insert 18 has a pivot axis 28 around which said insert is pivotable. The support frame 20 is connected to the wall panel 10 by way of a hydraulic cylinder 38. The hydraulic cylinder 38 and a controller (not shown) activating said cylinder control the movement of the burner insert 18 in or against the direction of the arrow 30 around the pivot axis 28. In an alternative embodiment that is not shown, the hydraulic cylinder 38 is replaced by a chain or gear wheel drive or similar.

FIG. 1 shows a situation in which the burner insert 18 or support frame 20 is located in a park position P. A front plate 34 of the support frame 20 facing the inner chamber 32 of the arc furnace 2 consequently ends flush with the inner side of the side wall 14. If during loading, that is to say charging, of the arc furnace 2, steel scrap (not shown) is now input into said furnace in the direction of the arrow 36, the scrap, when falling, cannot damage the burner insert 18. For this purpose the front plate 34 is implemented particularly solidly or robustly. During loading of the arc furnace 2 the burners 22 are not active or are merely operated with a so-called pilot flame.

FIG. 2 shows the arc furnace 2 at a later time during the melting operation. The burner 22 is active and the burner flame 24 is switched on. Compared with the park position P in FIG. 1, the entire burner insert 18, that is to say the support frame 20 with the burner 22 fixed to it, is swiveled through roughly 50° around the pivot axis 28 in the direction of the arrow 30. The flame direction 26 is consequently then likewise oriented in the direction toward the bottom vessel 4 so that the burner flame 24 is aligned in the direction of the steel scrap (not shown) located there in order to melt said steel in optimal fashion.

FIG. 2 accordingly shows an operating position A of the burner insert 18. In contrast to the park position P from FIG. 1, in which support frame 20 and burner 22 are located outside the inner chamber 32 of the arc furnace 2, said frame and burner now lie at least partly in the inner chamber 32. The support frame 20 is shaped like a segment of a circle—roughly in the nature of a piece of pie—with reference to the pivot axis 28. Both in the park position P and in the operating position A, and also in intermediate settings, the support frame 20 always fills the wall opening 16 almost completely or without gaps.

Together with the support frame 20, the burner 22 can also take up any desired intermediate settings between the operating position A and the park position P. In the embodiment shown, the burner 22 is spaced apart at a spacing d from the pivot axis 28. During pivoting of the burner insert 18, the entire burner 22 consequently executes a movement due to which the outlet aperture 25 of the burner 22, from which the burner flame 24 emerges, also varies its spacing from the wall panel 10. Thus, the flame direction 26 can be oriented as desired between the horizontal location in FIG. 1 and the inclined location in FIG. 2. Thus, the burner flame 24 is, for example, always optimally oriented toward the steel scrap to be melted, which, at least at the start of the melting process, also protrudes from the bottom vessel 4 into the top vessel 6 and settles fully into the bottom vessel 4 in the course of melting. Generally, during the meltdown phase of the steel scrap, the burner insert 18 is consequently left temporarily in intermediate settings between the park position P and the operating position A. Not until the so-called flat bath or refining phase is the operating position finally assumed, for example for jet operation of oxygen injectors (not shown) in the burner 22 for foamed slag formation, in order to achieve a maximum effect or maximum reach of the oxygen or burner flame 24 toward the molten steel. The corresponding tracking or selection of the positions A and P or intermediate positions takes place as a rule automatically by a controller (not shown).

In the operating position A and the aforesaid intermediate positions, the front plate 34 is oriented toward the steel scrap or molten metal in the bottom vessel 4 and thus protects the burner 22 from metal splashing up for example. The spacing shown in FIG. 2 of the outlet aperture 25 of the burner 22 from the wall panel 10 means that the refractory material of the bottom vessel 4 in particular is protected since the flame direction 26 passes by said vessel.

Finally, FIG. 3 shows the arc furnace 2 during a maintenance downtime, i.e. with the burner 2 switched off. In this case the burner insert 18 is swiveled starting from the operating position A through the park position P farther against the direction of the arrow 30 into a maintenance position W. In FIG. 3, the hydraulic cylinder 38 is removed or decoupled for maintenance purposes. The support frame 20 is consequently set down on a panel support 40. The entire burner insert 18, in particular also the burner 22 itself and in particular its outlet aperture 25, now lie completely in an outer chamber 42 of the arc furnace 2. Thus, the burner insert 18 or its component parts can be maintained, cleaned or replaced. This applies in particular if the burner insert 18 is constructed in modular fashion so that, for example, the front plate 34 can be replaced easily.

The panel support 40 can also be removed so that the burner insert 18 can be swiveled or lowered even farther against the direction of the arrow 30 to make said insert even more accessible—for example for welding work in the area of the outlet aperture 25.

Alternatively, the entire burner insert 18 can also be detached at the pivot axis 28 and removed. Thus, said insert can be swapped, for example for a new burner insert 18.

In FIG. 3, the embodiment of the support frame 20 or its external surface 44 in the shape of a segment of a circle can once again be particularly clearly identified with reference to the pivot axis 28. In this regard it can be particularly clearly identified in FIG. 1 that the pivot axis 28 extends horizontally underneath the burner 22 in the installed state of the burner insert 18 in the wall panel 10 as shown in the figures. In particular, said axis runs at the lower edge of the wall opening 16 and therefore at the lower edge of the entire burner insert 18. Thus, given the external shape shown, which is in the nature of a piece of pie, the burner insert 18 can always entirely fill the wall opening 16 in all rotary settings in which it penetrates said opening.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-7. (canceled)

8. A burner insert for an arc furnace, comprising:
a support frame pivotably mounted about a pivot axis, in a wall opening of a side wall of the arc furnace; and
a burner arranged in the support frame, wherein
the support frame pivots between a park position and an operating position,
in the park position, the support frame and the burner are located outside an inner chamber of the arc furnace,
in the operating position, the burner insert is installed in the arc furnace, and
in the operating position, the support frame and the burner are located at least partially inside the inner chamber of the arc furnace.

9. The burner insert as claimed in claim 8, wherein
the support frame pivots between the park position, the operating position and a maintenance position, and
in the maintenance position, the burner and the support frame are located in an outer chamber of the arc furnace so that the burner and the support frame are accessible from the outer chamber.

10. The burner insert as claimed in claim 8, wherein the support frame penetrates the wall opening such that it almost completely fills the wall opening both in the operating position and in the park position.

11. The burner insert as claimed in claim 10, wherein the support frame has an external surface embodied essentially as a segment of a circle with reference to the pivot axis.

12. The burner insert as claimed in claim 11, wherein the external surface of the support frame moves through the wall opening as the support frame pivots between the park position and the operating position.

13. The burner insert as claimed in claim 8, wherein the burner is radially spaced apart from the pivot axis.

14. The burner insert as claimed in claim 13, wherein, with respect to a vertically burning flame, the pivot axis extends horizontally underneath the burner when the support frame is in the operating position.

15. The burner insert as claimed in claim 8, wherein the burner is radially spaced apart from the pivot axis such that the burner rotates though an arc when the support frame pivots.

16. The burner insert as claimed in claim 8, wherein the burner insert has a movement activation device to swivel the support frame, vary the operating position and track the burner with a melting process in the arc furnace.

17. The burner insert as claimed in claim 16, further comprising a measurement system to measure variations in the melting process.

18. The burner insert as claimed in claim 8, wherein a movement activation device comprising a hydraulic cylinder pivots the support frame between the park position and the operating position.
